(19) United States
(12) Patent Application Publication
(10) Pub. No.: US 2012/0330987 A1
(43) Pub. Date: Dec. 27, 2012

(54) CONTENT PROVIDING METHOD AND SYSTEM FOR TRANSMITTING METADATA EXTRACTED FROM CONTENT

(75) Inventors: Ram LEE, Seongnam-si (KR); Jangyeon PARK, Seongnam-si (KR); Gun Woong LEE, Seongnam-si (KR)

(73) Assignee: NHN CORPORATION, Seongnam-si (KR)

(21) Appl. No.: 13/351,124

(22) Filed: Jan. 16, 2012

(30) Foreign Application Priority Data
Jun. 21, 2011 (KR) 10-2011-0060171

(51) Int. Cl. G06F 17/30

(52) U.S. Cl. 707/758; 707/705; 707/E17.01; 707/E17.032; 707/E17.014

(57) ABSTRACT

Provided is a content providing method and system for extracting and transmitting metadata. When a user uploads a content file, metadata of content may be extracted from the content file. The extracted metadata of the content may be transmitted to a terminal of the user and the user may select content based on the metadata. The content selected using the uploaded content file may be provided to the user through downloading or streaming.

### CROSS REFERENCE TO RELATED APPLICATION

This application claims priority from and the benefit of Korean Patent Application No. 10-2011-0060171, filed on Jun. 21, 2011, which is hereby incorporated by reference for all purposes as if fully set forth herein.

### BACKGROUND OF THE INVENTION

1. Field of the Invention

Exemplary embodiments of the present invention relate to a method and system for providing content, and to a method and system for extracting metadata from content and providing the extracted metadata to a terminal.

2. Discussion of the Background

A cloud service is a service that enables users to store files in a central server, and to retrieve and use the stored files using terminals, for example, smart phones and personal computers (PCs).

Using the cloud service, a user may access an account of the user over a wired or wireless network and may use a file of the user irrespective of a location of the user or terminal being used by the user.

The central server providing the cloud service may store a file of a user. The stored file may be provided to the user through a general file transmission and/or a streaming service. In addition, a server of the cloud service may provide an additional service by storing and managing a file of a user.

### SUMMARY OF THE INVENTION

Exemplary embodiments of the present invention provide a content providing method and system for extracting metadata within a content file and providing the extracted metadata to a terminal.

Exemplary embodiments of the present invention also provide a content providing method and system that may receive a content request from a terminal receiving metadata and may provide requested content.

Additional features of the invention will be set forth in the description which follows, and in part will be apparent from the description, or may be learned by practice of the invention.

Exemplary embodiments of the present invention disclose a content providing method executed by a processor. The method includes receiving a file including content, from a user terminal and storing the file. The method also includes extracting, using the processor, metadata of the content, and storing the metadata in association with information used to identify the file. The method further includes transmitting the metadata and the information to the terminal, receiving a request for the content from the terminal, and providing the content to the terminal.

Exemplary embodiments of the present invention also disclose a content providing method executed by a processor. The method includes receiving a file including content, from a first terminal, storing the file, and extracting, using the processor, metadata of the content. The method also includes storing the metadata in association with information used to identify the file, transmitting the metadata and the information to a second terminal, receiving a request for the content from the second terminal, and providing the content to the second terminal.

Exemplary embodiments of the present invention also disclose a system to provide content. The system includes an application programming interface (API) server to receive a file including content from a first terminal, and to receive a request for the content from a second terminal. The system also includes a storage server to store the file, and to provide the content to the second terminal. The system further includes a file processing server to extract metadata of the content, and a database server to store the extracted metadata in association with information used to identify the file, and to provide the stored metadata and the information to the second terminal.

Exemplary embodiments of the present invention also disclose a server including an application programming interface (API) unit to receive a file including content from a first terminal, and to receive a request for the content from a second terminal. The system further comprising a file storage unit to store the file, and to provide the content to the second terminal, a file processing unit to extract metadata of the content; and a database unit to store the extracted metadata in association with information used to identify the file, and to provide the stored metadata and the information to the second terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating an operation of a content providing system according to exemplary embodiments of the present invention.

FIG. 2 is a flowchart illustrating a content providing method according to exemplary embodiments of the present invention.

FIG. 3 is a block diagram illustrating a structure of a content file according to exemplary embodiments of the present invention.

FIG. 4 is a flowchart illustrating a method of extracting metadata of content based on data within a metadata area according to exemplary embodiments of the present invention.

FIG. 5 is a diagram illustrating a method of determining metadata of content according to exemplary embodiments of the present invention.

FIG. 6 is a view of requesting content using metadata according to exemplary embodiments of the present invention.

FIG. 7 is a block diagram illustrating a configuration of a server according to exemplary embodiments of the present invention.

FIG. 8 is a diagram to describe load balancing among a plurality of servers according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region, or substrate is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. It should be understood that for the purposes of this disclosure, “at least one of X, Y, and Z” can be construed as X only, Y only, Z only, or any combination of two or more items X, Y, and Z (e.g., XYZ, XYY, YZ, ZZ).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be explained in detail with reference to the accompanying drawings.

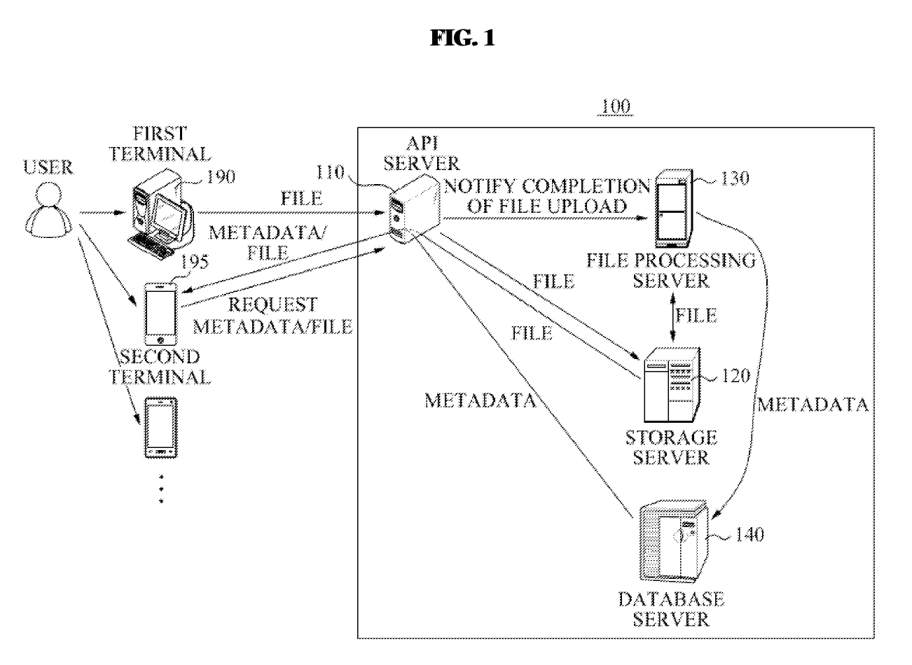

FIG. 1 is a diagram illustrating an operation of a content providing system 100 according to exemplary embodiments of the present invention.

Referring to FIG. 1, the content providing system 100 (hereinafter, the system 100) may include an application programming interface (API) server 110, a storage server 120, a file processing server 130, and a database server 140.

The API server 110 may correspond to a server that provides an API for communication with a terminal of a user among servers of the content providing system 100.

The terminal may receive a service of the system 110 through the API server 110. For example, the API server 110 may receive a file from the terminal, and may transmit the received file to the storage server 120. The API server 110 may receive a request for a predetermined file or content from the terminal, and may transmit the received request to the storage server 120 and the database server 140.

The API server 110 may receive the predetermined file or content from the storage server 120 and/or the database server 140, and may transmit the received file or content to the terminal.

The file may be a content file. The content file may correspond to a file including content. For example, the content file may be a file that can be played back in a terminal to thereby provide the content to the user of the terminal.

The storage server 120 may store a file of the user provided from the terminal, and may provide the stored file to the terminal in response to a request of the user. The storage server 120 may provide the file or the content to the terminal directly or via the API server 110.

The file processing server 130 may extract metadata from a file of the user. The file may be stored in the terminal (e.g., user terminal), the storage server 120, and/or the database server 140. The file processing server 130 may transmit the extracted metadata to the database server 140.

The database server 140 may store the metadata and any file associated with the user. The database server 140 may store the metadata in association with the file of the user. For example, the database server 140 may store the metadata of the file associated with an identifier of the file or an access path of the file.

The user may specify, via the terminal a requested file using an identifier of the file or a path of the file. The path of the file may have a hierarchical structure.

The database server 140 may provide the metadata to the terminal directly or via the API server 110.

The user may utilize a service of the system 100 using a terminal. The terminal may have a various functions and capabilities. The terminal may be, for example, a personal computer (PC), a smart phone, and in general, may be any suitable portable electronic device capable of connecting to a network through a wired or wireless connection. The terminal may be a mobile terminal.

In FIG. 1, a first terminal 190 may correspond to a terminal that uploads a file to the system 100, and a second terminal 195 may correspond to a terminal that receives a service for the uploaded file. For example, the second terminal 195 may indicate a terminal that requests the system 100 for metadata of an uploaded file.

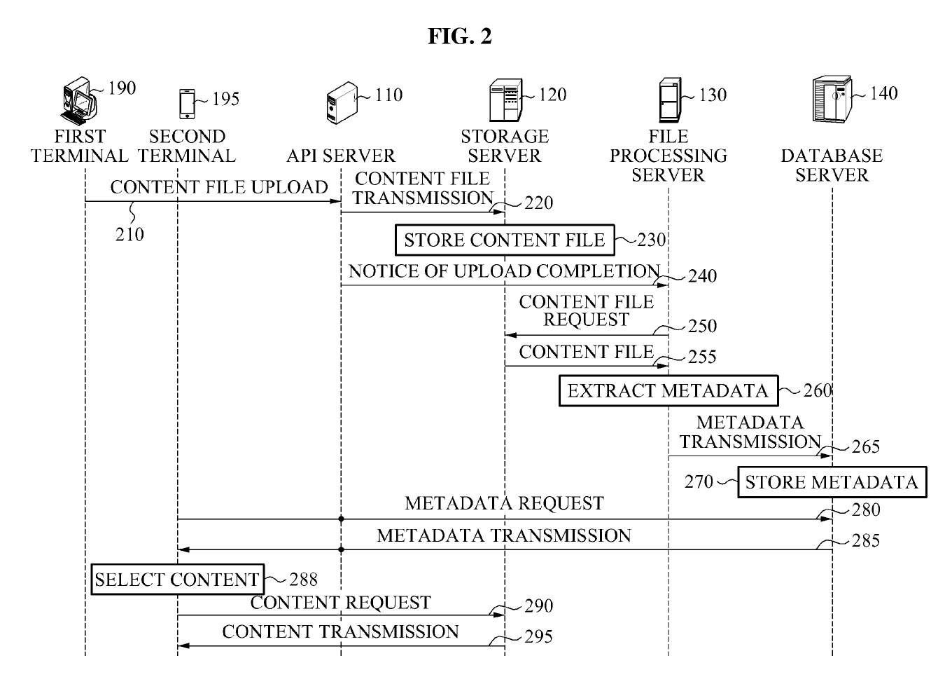

FIG. 2 is a flowchart illustrating a content providing method according to exemplary embodiments of the present invention.

Referring to FIG. 2, a user may access the API server 110 of system 100 using the first terminal 190 and the second terminal 195.

The first terminal 190 may be a terminal used by the user to upload a content file. The second terminal 195 may be a terminal used when the user plays back content of the uploaded content file is to be played back.

The first terminal 190 and the second terminal 195 may have the same and/or different functions and capabilities. The first terminal 190 and the second terminal 195 may be, for example, a personal computer (PC), a smart phone, and, in general, may be any suitable portable electronic device capable of connecting to a network through a wired or wireless connection. In some cases, the first terminal 190 and the second terminal 195 may be the same terminal.

Referring to FIG. 2 in 210, the first terminal 190 may transmit a content file storing content to the API server 110. The API server 110 may receive the content file storing the content, from the first terminal 190. The transmission may be a file upload using a Hypertext Transfer Protocol (HTTP). In general, various suitable upload techniques may be used to upload the content file to the API server 110.

In 220, the API server 110 may transmit the content file to the storage server 120.

In 230, the storage server 120 may store the transmitted content file.

In 240, the API server 110 may notify the file processing server 130 that uploading of the content file is completed.

The API server 110 may transmit, to the file processing server 130, information used to identify the content file together with a notice that uploading of the content file is complete. Information used to identify the content file may be an identifier of the content file or a path of the content file.

Here, 230 and 240 may be performed in parallel or may inversely be performed.

In 250, the file processing server 130 receiving the notice may request the storage server 120 for the content file based on the information used to identify the content file.

In 255, in response to the request the storage server 120 may transmit the content file to the file processing server 130.

In 260, the file processing server 130 may extract metadata associated with content in the content file based on data within a metadata area of the content file.

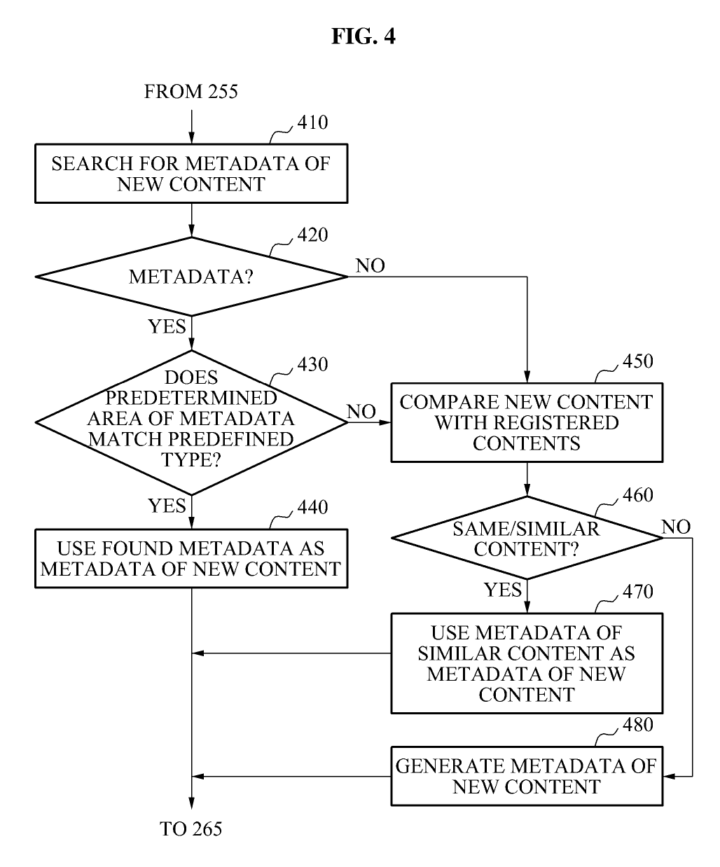

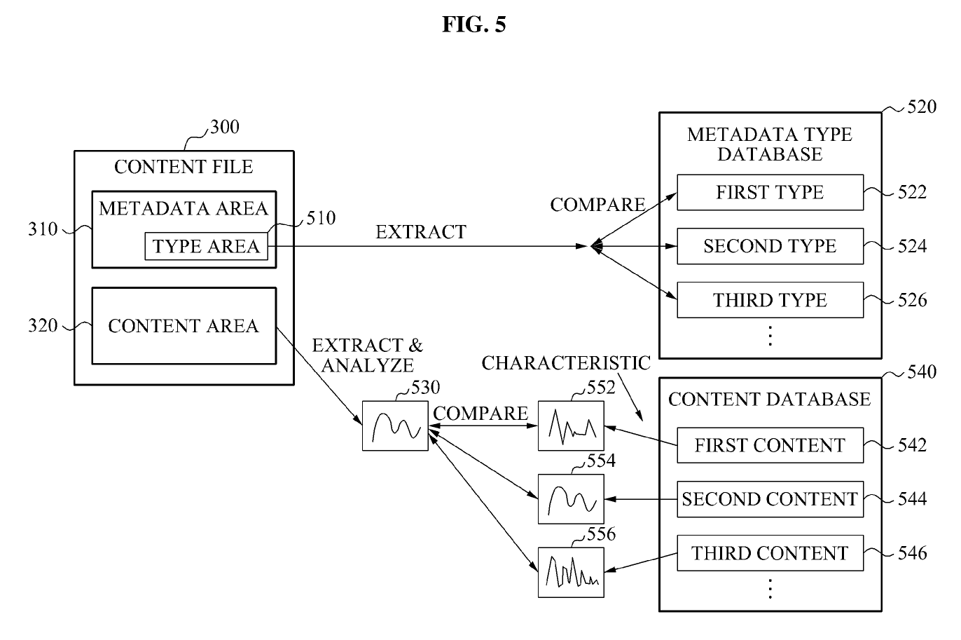

A method of extracting metadata of content based on data within a metadata area of a content file will be further described with reference to FIG. 4 and FIG. 5.

In 265, the file processing server 130 may transmit the extracted metadata to the database server 140.

In this example, the file processing server 130 may transmit, to the database server 140, information used to identify the content file together with the extracted metadata.

In 270, the database server 140 may store the transmitted metadata.

The database server 140 may store the transmitted metadata associated with a content file and information used to identify the content file.

In 280, the second terminal 195 may request the API server 110 for metadata. In response to the request, the API server 110 may request the database server 140 for the metadata.

The second terminal 195 may request metadata of the content file using information used to identify the content file. In some cases the second terminal 195 may request metadata with respect to all of files stored in the system 100. In some cases the second terminal 195 may request metadata with respect to files that satisfy a predetermined criterion among the files stored in the system 100. For example, the second terminal 195 may request metadata with respect to files within a predetermined folder, files of a predetermined group, and/or files having common subject matter or names.

In 285, the database server 140 may transmit the requested metadata and the information used to identify the content file to the API server 110, and the API server 110 may transmit the received metadata to the second terminal 195, which means the database server 140 may provide the stored metadata and information used to identify the content file to the second terminal 195 via the API server 110.

In 285, the database server 140 may transmit the requested metadata and the information used to identify the content file to the API server 110, and the API server 110 may transmit the received metadata and information used to identify the content file to the second terminal 195.

When metadata requested in 280 corresponds to metadata of at least one file or at least one content, metadata transmitted in 285 may correspond to metadata of at least one file or at least one content.

In 288, content may be selected by a user of the second terminal 195. The user may select the content using only metadata of the content instead of using a file name of the content file or a file path.

For example the second terminal 195 may display the received metadata on a display unit of the second terminal 195. The user may view the metadata of the displayed content and select content associated the metadata.

In 290, the second terminal 195 may request the API server 110 for the selected content. The API server 120 may further request the storage server 120 for the selected content.

The second terminal 195 may request the content using information used to identify the content file.

In 295, the storage server 120 may transmit the requested content to the API server 110 using the stored content file. The API server 110 may transmit the transmitted content to the second terminal 195.

The storage server 120 may identify a file of content to be transmitted, based on the information used to identify the content file.

The content may be provided to the second terminal 195 through downloading of the content file or streaming of the content.

When the content may be transmitted through downloading, the storage server 120 may provide the stored content file to the second terminal 195.

When the content may be transmitted through streaming, the storage server 120 or the API server 110 may convert the stored content file to a type for streaming compatibility and then provide data of the converted type to the second terminal 195.

In 290, the second terminal 195 may also transmit information about specification of the second terminal 195, performance of the second terminal 195, and a network characteristic together with the request for content. The second terminal 195 may represent reception of the metadata and the information and transmission of the request as an access to a virtual storage that is provided from application executed in the second terminal 195.

The storage server 120 or the API server 110 may convert the content file for streaming to be suitable for the specification of the second terminal 195, the performance of the second terminal 195, and/or the network characteristic, and may provide data of the converted type to the second terminal 195. The second terminal 195 may play back the content using the provided data.

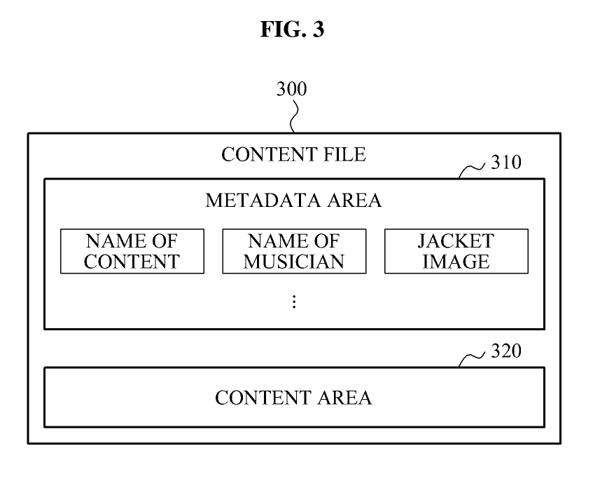

FIG. 3 is a block diagram illustrating a structure of a content file 300 according to exemplary embodiments of the present invention.

Referring to FIG. 3, the content file 300 may include a metadata area 310 and a content area 320.

The metadata area 310 may correspond to an area for storing description of the content stored in the content file 300.

The content file 300 may be any file that may be executable by a processor of a computer or electronic device. For example, the content file 300 may be a multimedia file that may include audio and/or video content.

In some cases the content file 300 may be a file in a Moving Picture Experts Group (MPEG) layer-3 (MP3) format. The metadata area 310 may include an ID3 (a metadata container used in conjunction with the MP3 audio file format) tag of the MP3 format file.

The metadata may include, for example, at least one of a name of the content, a musician of the content, and a jacket image of the content. In this example, the musician may include a singer, a player, a composer, and/or a lyric writer. In general, the metadata may include a number and character string, a sound, and/or an image.

FIG. 4 is a flowchart illustrating a method of extracting metadata of content based on data within a metadata area according to exemplary embodiments of the present invention.

410 through 480 may be performed by the file processing server 130 of FIG. 1.

Extracted metadata may be newly registered to the system 100. Therefore, content of a file in which metadata may be extracted may be referred to as new content.

In 410, the file processing server 130 may search for metadata within the metadata area 310 of the content file 300.

In 420, whether the metadata is present may be determined. When metadata is determined to be present, 430 may be performed. When the metadata is determined to be absent, 450 may be performed.

In 430, whether a predetermined area within the metadata area 310 matches a predefined type of area may be verified. When the predetermined area within the metadata area 310 matches the predefined type of area, 440 may be performed. When the predetermined area within the metadata area does not match the predefined type of area, 450 may be performed.

When the predetermined area within the metadata area 310 matches the predefined type of area, the metadata may be used within the system 100.

Therefore, the system 100 may store at least one predefined type of area in the file processing server 130 or the database server 140, and may use the metadata when the predetermined area within the metadata area 310 matches one of the at least one predefined type of area.

In 440, the found metadata may be used as metadata of new content. For example, metadata extracted from the content file 300 may be used as metadata of the content.

In 450 through 470, metadata may be generated by comparing the content with registered contents based on the content file 300.

In 450, content of the content file 300 may be compared with the contents registered within the system 100.

In 460, the file processing server 130 may determine whether content of the content file 300 is the same as or similar as the contents registered within the system 100.

When the content of the content file 300 is the same or similar as at least one the contents registered within the system 100, 470 may be performed. Otherwise, 480 may be performed.

In 470, metadata of the same or similar content may be determined may be used as the metadata of the content of the content file 300.

In this example, the metadata found within the metadata area 310 of the content file 300 may partially be used as metadata of the content.

In 480, the metadata of the content of the content file 300 may be generated.

The metadata found within the metadata area 310 of the content file 300 may be partially used as the metadata of the content.

In some cases, the metadata of the content may be determined to be an unknown value. For example, a value such as a name of content name or a musician name may be set to “unknown”.

In some cases, the metadata of the content may be generated based on a user input value.

In some cases, the metadata of the content may be generated based on a file name of the content file 300. For example, the value such as a content name or a musician name may be a portion of the file name of the content file 300 which may be separated by a predetermined classifier such as “-”.

FIG. 5 is a diagram illustrating a method of determining metadata of content according to an exemplary embodiment of the present invention.

The file processing server 130 may compare a type area 510 of the content file 300 with each of at least one type, for example, a first type 522, a second type 524, and a third type 526, stored in a metadata type database 520.

The type area 510 may be a predetermined area within the metadata area 310 as described above in 430. At least one type stored in the metadata type database 520 may correspond to a predefined type described above with reference to FIG. 4.

For example, the file processing server 130 may extract the type area 510 from the content file 300, and may verify whether the extracted type area 510 matches a type stored in the metadata type database 520.

When a matching type is present, the file processing server 130 may perform 440 of FIG. 4. When the matching type is absent, the file processing server 130 may perform 450.

The metadata type database 520 may be included in the file processing server 130 or the database server 140.

The file processing server 130 may extract and analyze a characteristic of content from the content area 320 of the content file 300.

The file processing server 130 may compare the extracted and analyzed characteristic of content with a characteristic of each of at least one content stored in a content database 540. For example, the file processing server 130 may compare the characteristic of content with each of a characteristic 552 of first content 542, a characteristic 554 of second content 544, and a characteristic 556 of content 546.

Through the above comparison, the file processing server 130 may verify whether registered content is the same as or similar to content of the content file 300 is present. For example, when the characteristic of content of the content file 300 is the same as or similar to the characteristic of the content stored in the content database 540, both contents may be regarded to be the same or similar.

The above characteristic may be characteristic information of content, and may be a feature vector of the content.

In some cases, the characteristic may be a file name of the content file 300.

When a registered content is the same as or similar to the content of the content file 300, the file processing server 130 may perform 470. When a registered content is not the same as or similar to the content of the content file 300 is absent, the file processing server 130 may perform 480.

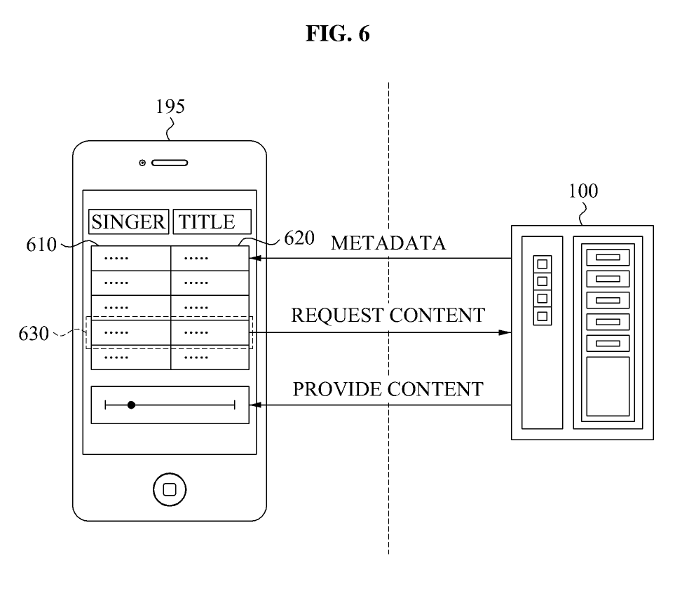

FIG. 6 is a view of requesting content using metadata according to exemplary embodiments of the present invention.

A user of the second terminal 195 may request the system 100 for metadata with respect to at least one content. The request may be performed according to 280 of FIG. 2.

The user may have a right to access at least one content.

In response to the request, the system 100 may transmit metadata of the at least one content to the second terminal 195.

The transmitted metadata, for example, a signer 610 and a title 620 may be displayed on a display unit of the second terminal 195.

The singer 610 may be a list of singers of at least one content.

The title 620 may be a list of titles of the at least one content.

The user may view a description, i.e., metadata of the at least one content which may be displayed on the second terminal 195, and may select one or more content. For example, the user may select a content based on metadata stored in the content file 300, regardless of a file name and/or a path of the at least one content, and the like.

The second terminal 195 may request the system 100 to transmit the selected content 630, as described above with reference to 290.

The system 100 may provide the requested content 630 to the second terminal 195, as described above with reference to 295.

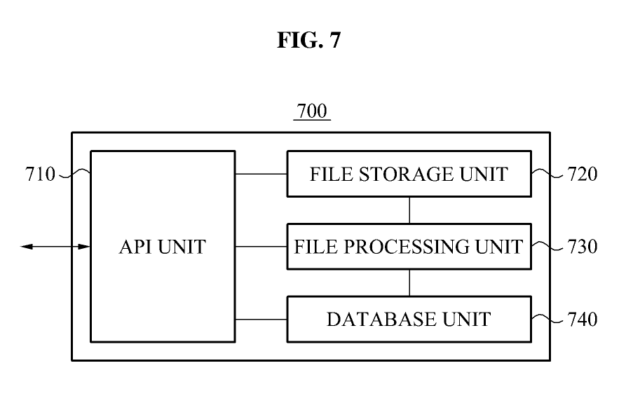

FIG. 7 is a block diagram illustrating a configuration of a server 700 according to exemplary embodiments of the present invention.

The content providing method described above with reference to FIG. 1 through FIG. 6 may be provided by, in some cases, a single system such as a server, and, in some cases, a network of multiple systems.

The server 700 may include an API unit 710, a file storage unit 720, a file processing unit 730, and a database unit 740.

The API unit 710 may correspond to the API server 110 of FIG. 1, and may perform a functionality of the API server 110.

For example, the API unit 710 may receive the content file 300 storing content from the first terminal 190, and may receive a request for content from the second terminal 195.

The file storage unit 720 may correspond to the storage server 120, and may perform a functionality of the storage server 120.

For example, the file storage unit 720 may store the content file 300, and may provide the content to the second terminal 195 using the content file 300.

The file processing unit 730 may correspond to the file processing server 130, and may perform a functionality of the file processing server 130.

For example, the file processing unit 730 may extract metadata of content based on data within the metadata area 310 of the content file 300.

The database unit 740 may correspond to the database server 140, and may perform a functionality of the database server 140.

For example, the database unit 740 may store the extracted metadata, and may provide the extracted metadata to the second terminal 195.

Also, the API unit 710, the file storage unit 720, the file processing unit 730, and the database unit 740 may be integrated into at least one server, and the at least one server may perform communication over an internal network.

The exemplary embodiments described above with reference to FIG. 1 through FIG. 6 may be applicable to FIG. 7 and thus, further detailed description will be omitted here. For instance, the API unit 710, file storage unit 720, file processing unit 730, and database unit 740 may correspond to the API server 110, storage server 120, file processing server 130, and database server 140, and therefore a detailed description of the API unit 710, file storage unit 720, file processing unit 730, and database unit 740 is not provided here.

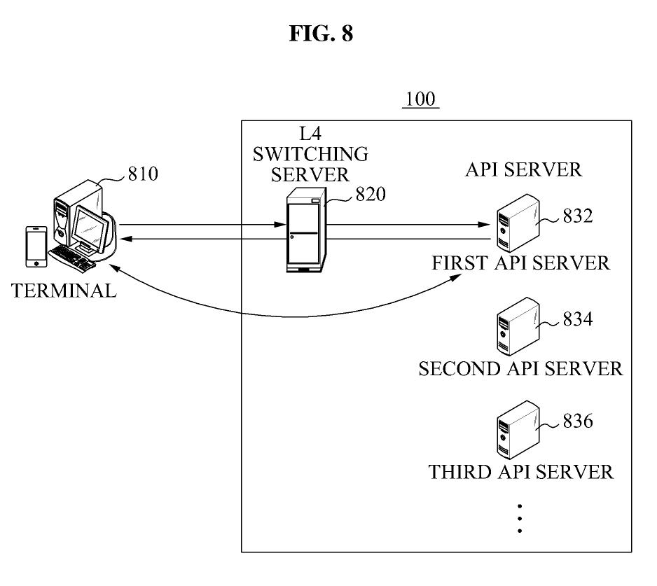

FIG. 8 is a diagram to describe load balancing among a plurality of servers according to exemplary embodiments of the present invention.

In general, a cloud service may be provided using a large server group.

For example, each server of the system 100, for example, the API server 110, the storage server 120, the file processing server 130, and the database server 140 may be implemented as one or more servers.

For example, in some cases, a plurality of API servers 110 may be provided to implement API server 110. In FIG. 8, three API servers, for example, a first API server 832, a second API server 834, and a third API server 836 are shown.

The system 100 may include a layer 4 (L4) switching server 820.

The L4 switching server 820 may perform load balancing among the plurality of servers.

When a terminal 810 desires to access the system 100, an API server to process a service for the terminal 810 may need to be determined among the plurality of servers.

In 210, when the first terminal 190 transmits a content file, the L4 switching server 820 may determine which API server to receive the content file from the terminal 810, from amongst the plurality of API servers.

Also, in 280, when the second terminal 195 requests metadata, the L4 switching server 820 may determine which API server to receive the request for the metadata, from amongst the plurality of API servers.

In some cases, 280 may include 1) an operation of determining which API server receives a request for content among a plurality of API servers, and 2) an operation of receiving, by the determined API the request for content, the request for content from the second terminal 190.

Also, each of constituent elements of the server 700, for example, the API unit 710, the file storage unit 720, the file processing unit 730, and the database unit 740 may be implemented as one or more elements.

For example, a plurality of API units 710 may be provided, and the server 700 may further include an L4 switching unit (not shown).

The L4 switching unit may select one constituent element to perform 210 through 295 from among the plurality of constituent elements, for example, the plurality of API units 710, a plurality of file storage units 720, a plurality of file processing units 730, or a plurality of database units 740.

For example, the L4 switching unit may determine a first API unit to receive a content file from the first terminal 190 among the plurality of API units 710, and may determine a second API unit to receive a request for metadata from the second terminal 195 among the plurality of API units 710.

The exemplary embodiments described above with reference to FIG. 1 through FIG. 7 may be applicable to FIG. 8 and thus, a further detailed description will be omitted here.

The exemplary embodiments according to the present invention may be implemented in numerous ways. For example, the exemplary embodiments may be implemented using hardware, software, or a combination thereof. When implemented in software, the software code can be executed on any suitable processor or collection of processors, whether provided in a single computer or distributed among multiple computers. It should be appreciated that any component or collection of components that perform the functions described above can be considered as one or more controllers that control the above-discussed function. The one or more controller can be implemented in numerous ways, such as with dedicated hardware, or with general purpose hardware (e.g., one or more processor) that is programmed using microcode or software to perform the functions recited above. For example, the API server 110 or the file processing server 130 described hereinabove may each include a controller implemented in hardware. The respective controllers may implement the various exemplary embodiments described hereinabove.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

It should be appreciated that exemplary embodiments of the invention are also directed to a computer readable medium encoded with one or more programs including instructions that, when executed on one or more computers or other processors, perform methods that implement the various exemplary embodiments of the invention discussed above. The computer-readable media may include, but are not limited to, transitory and non-transitory media, and volatile and non-volatile memory. The computer-readable media may include storage media, such as, for example, read-only memory (ROM), random access memory (RAM), floppy disk, hard disk, optical reading media (e.g., compact disc-read-only memory (CD-ROM), digital versatile discs (DVDs), hybrid magnetic optical disks, organic disks, flash memory drives or any other volatile or non-volatile memory, and other semiconductor media. In some cases, the computer-readable media may be electronic media, electromagnetic media, infrared, or other communication media such as carrier waves. Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable storage media can store and execute computer-readable codes that are distributed in computers connected via a network. The computer-readable media also includes cooperating or interconnected computer-readable media that are in the processing system or are distributed among multiple processing systems that maybe local or remote to the processing system. The computer readable medium or media can be transportable, such that the program or programs stored thereon can be loaded onto one or more different computers or other processors to implement various aspects of the present invention as discussed above.

Various aspects of the invention may be implemented on one or more computer systems. Such computer systems may include input device(s), output device(s), processor(s), memory system(s), and storage unit(s), all or some of which are coupled, directly or indirectly, via an interconnection mechanism, which may be comprised of one or more buses, switches, and/or networks. The input device(s) may receive input from a user or terminal, and the output device(s) may display or transmit information to a user or a terminal. The processor(s) may execute a computer program (e.g., an operating system) which controls the execution of other computer programs, and provides scheduling, input/output and other device control, accounting, compilation, storage assignment, data management, memory management, communication, and data flow control.

The processor(s) may also execute one or more computer programs or software to implement various exemplary embodiments of the invention. These computer programs may be written in any type of computer programming language, including a procedural programming language, object-oriented programming language, macro language, or combination thereof. These computer programs may be stored in a storage system, which may hold information on a volatile or nonvolatile medium, and may be fixed or removable.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A content providing method executed by a processor, the method comprising:
receiving a file comprising content, from a terminal;
storing the file;
extracting, using the processor, metadata of the content;
storing the metadata in association with information used to identify the file;
transmitting the metadata and the information to the terminal;
receiving a request for the content from the terminal; and
providing the content to the terminal.

2. The method of claim 1, further comprising receiving a selection, via the terminal, of the content based on the metadata.

3. The method of claim 1, wherein the terminal represents reception of the metadata and the information and transmission of the request as an access to a virtual storage provided from an application executed in the terminal.

4. The method of claim 1, wherein:
the terminal is a mobile terminal,
the metadata is displayed on a display unit of the mobile terminal, and
the mobile terminals plays back the provided content.

5. The method of claim 1, wherein the metadata is extracted based on data within a determined area of the file, and wherein the file comprises a file of a Moving Picture Experts Group (MPEG) audio layer-3 (MP3) format, the determined area comprises an ID3 metadata area of the MP3 format file, and the content comprises audio content.

6. The method of claim 5, wherein the metadata comprises at least one of a name of the content, a name of a musician of the content, and an image of the content.

7. The method of claim 1, wherein the content is provided to the terminal through downloading of the file or streaming of the content.

8. The method of claim 1, wherein the extracting comprises:
searching for the metadata within a determined area of the file; and
comparing the content with registered contents in response to the metadata not being found within the determined area.

9. The method of claim 1, wherein the extracting comprises:
comparing the content with registered content in response to an area of the file not matching a determined type of area.

10. The method of claim 1, wherein receiving the file comprises:
determining an application programming interface (API) server to receive the file among a plurality of API servers; and
receiving, by the determined API server, the file from the terminal, and
wherein receiving the request comprises:
determining an API server to receive the request for the content among the plurality of API servers; and
receiving, by the API server determined to receive the request for the content, the request for the content from the terminal.

11. A content providing method executed by a processor, the method comprising:
receiving a file comprising content, from a first terminal;
storing the file;
extracting, using the processor, metadata of the content;
storing the metadata in association with information used to identify the file;
transmitting the metadata and the information to a second terminal;
receiving a request for the content from the second terminal; and
providing the content to the second terminal.

12. The method of claim 11, further comprising receiving a selection, via the second terminal, of the content based on the metadata.

13. The method of claim 11, wherein the second terminal represents reception of the metadata and the information and transmission of the request as an access to a virtual storage provided from an application executed in the terminal.

14. The method of claim 11, wherein:
the second terminal is a mobile terminal,
the metadata is displayed on a display unit of the mobile terminal, and
the mobile terminals plays back the provided content.

15. The method of claim 11, wherein the metadata is extracted based on data within a determined area of the file, and wherein the file comprises a file of a Moving Picture Experts Group (MPEG) audio layer-3 (MP3) format, the determined area comprises an ID3 metadata area of the MP3 format file, and the content comprises audio content.

16. The method of claim 15, wherein the metadata comprises at least one of a name of the content, a name of a musician of the content, and an image of the content.

17. The method of claim 11, wherein the content is provided to the second terminal through downloading of the file or streaming of the content.

18. The method of claim 11, wherein the extracting comprises:
searching for the metadata within a determined area of the file; and
comparing the content with registered content in response to the metadata is not found within the determined area.

19. The method of claim 11, wherein the extracting comprises:
comparing the content with registered content in response to an area of the file not matching a determined type of area.

20. The method of claim 11, wherein receiving the file comprises:
determining an application programming interface (API) server to receive the file among a plurality of API servers; and
receiving, by the determined API server, the file from the first terminal, and
wherein receiving the request comprises:
determining an API server to receive the request for the content among the plurality of API servers; and
receiving, by the API server determined to receive the request for the content, the request for the content from the second terminal.

21. A non-transitory computer-readable recording medium comprising an executable program, which when executed by the processor, performs the method of claim 1.

22. A system to provide content, comprising:
an application programming interface (API) server to receive a file comprising content from a first terminal, and to receive a request for the content from a second terminal;
a storage server to store the file, and to provide the content to the second terminal;
a file processing server to extract metadata of the content; and
a database server to store the extracted metadata in association with information used to identify the file, and to provide the stored metadata and the information to the second terminal.

23. The system of claim 22, wherein the second terminal receives a selection of the content based on the metadata.

24. The system of claim 22, wherein the second terminal represents reception of the metadata and the information and transmission of the request as an access to a virtual storage provided from an application executed in the terminal.

25. The method of claim 22, wherein:
the second terminal is a mobile terminal,
the metadata is displayed on a display unit of the mobile terminal, and
the mobile terminals plays back the provided content.

26. The system of claim 22, wherein the metadata is extracted based on data within a determined area of the file, and wherein the file comprises a file of a Moving Picture Experts Group (MPEG) audio layer-3 (MP3) format, the determined area comprises an ID3 metadata area of the MP3 format file, and the content comprises audio content.

27. The system of claim 26, wherein the metadata comprises at least one of a name of the content, a name of a musician of the content, and an image of the content.

28. The system of claim 22, wherein the content is provided to the second terminal through downloading of the file or streaming of the content.

29. The system of claim 22, wherein, in response to the metadata not being found in a determined area of the file, the file processing server compares the content with registered content.

30. The system of claim 22, wherein in response to an area of the file not matching a determined type of area, the file processing server compares the content with registered content.

31. The system of claim 22, wherein:
the API server comprises a plurality of API servers, and
the system further comprises:
a layer 4 (L4) switching server to determine a first API server to receive the file from the first terminal, and to determine a second API server to receive a request for the metadata from the second terminal.

32. The system of claim 22, wherein the storage server provides the file to the second terminal without changing the file.

33. A server, comprising:
an application programming interface (API) unit to receive a file comprising content from a first terminal, and to receive a request for the content from a second terminal;
a file storage unit to store the file, and to provide the content to the second terminal;
a file processing unit to extract metadata of the content; and
a database unit to store the extracted metadata in association with information used to identify the file, and to provide the stored metadata and the information to the second terminal.

34. The server of claim 33, wherein the API unit, the file storage unit, the file processing unit, and the database unit are integrated into at least one server and the at least one server performs a communication over an internal network.

35. The server of claim 33, wherein:
the API unit comprises a plurality of API units, and
the server further comprises:
a layer 4 (L4) switching unit to determine a first API server to receive the file from the first terminal, and to determine a second API server to receive a request for the metadata from the second terminal.

36. A non-transitory computer-readable recording medium comprising an executable program, which when executed by the processor, performs the method of claim 11.
